(19) United States
(12) Patent Application Publication
(10) Pub. No.: US 2018/0241865 A1
(43) Pub. Date: Aug. 23, 2018

(54) DISPLAY UNIT WITH A BASE

(71) Applicant: HEWLETT-PACKARD DEVELOPMENT COMPANY, L.P., Houston, TX (US)

(72) Inventors: Eric Y. Schee, Shanghai (CN); Jun Long, Shanghai (CN); Li Chen, Shanghai (CN)

(73) Assignee: HEWLETT-PACKARD DEVELOPMENT COMPANY, L.P., Houston, TX (US)

(21) Appl. No.: 15/753,941

(22) PCT Filed: Aug. 26, 2015
(86) PCT No.: PCT/CN2015/088099

§ 371 Date: Feb. 20, 2018

(51) Int. Cl. H04M 1/725; G06F 1/16; G06F 3/041; G06F 3/147; G09F 9/30

(52) U.S. Cl. CPC H04M 1/7253; G06F 1/1632; G06F 1/1652; G06F 1/1654; G06F 1/1641; G09G 2380/02; G06F 3/147; G09F 9/301; G06F 2203/04102; G09G 2370/16; G09G 2370/20; G06F 3/0412

(57) ABSTRACT

An example display system is disclosed. The display system comprises a flexible display screen having a plurality of divisions, and a base, attached to the display screen. The base establishes a connection between a plurality of devices and the display screen. Various instances from the plurality of devices are displayed simultaneously on the plurality of divisions of the display screen.

### BACKGROUND

With the recent development, the number of devices used by one or more people in one space has increased significantly. Moreover, the number of applications that can he used on these devices are increasing significantly as well. For example, in a single household, there may be multiple advanced mobile or handheld computing devices (e.g., smartphones, tablets, etc.) in addition to computers, laptops, cameras and many other devices, running many different applications on different operating systems. Each device is used by a user to view an instance.

### BRIEF DESCRIPTION OF THE DRAWINGS

Examples are described in the following detailed description and in reference to the drawings, in which:

FIG. 1 illustrates a schematic representation of an example display unit in accordance with an implementation of the present disclosure;

FIGS. 2A and 2B illustrate an example display unit in accordance with an implementation;

FIG. 3 illustrates an example system for displaying multiple instances in accordance with an implementation; and

FIG. 4 illustrates an example process flow diagram in accordance with an implementation.

### DETAILED DESCRIPTION

Various aspects of the present disclosure are directed to a single display system for multiple devices. More specifically, and as described in greater detail below, various aspects of the present disclosure are directed to a manner by which multiple devices operating in same or different operating systems may be displayed on one flexible, bendable and extendable screen.

Aspects of the present disclosure described herein disclose allowing the user to display content from a plurality of devices. Among other things, this approach allows interaction with multiple devices through one screen across multiple divisions. The user can case touch gestures to control all the devices on the same display. Moreover, aspects of the present disclosure described herein allow multiple instances to be displayed at the same time in a divided view on the screen. Each instance car be displayed on one division of the bendable screen. Among other things, this approach may provide the flexibility of using a single screen by a plurality of users. Moreover, when bended, the screens can be viewed privately without allowing others to see.

in one example in accordance with the present disclosure, a method for Managing a plurality of instances on a display screen of a display unit is provided. The method comprises establishing, by a base of the display unit, connection between the display unit and a plurality of devices, wherein the plurality of instances run on the plurality of devices, and wherein the display screen comprises a plurality of divisions; and displaying simultaneously on the plurality of divisions of the display screen the plurality of instances,

in another example in accordance with the present disclosure, a system is provided. The system comprises a flexible display screen having a plurality of divisions; and a base, attached to the display screen, establishing connection between a plurality of devices and the display screen, wherein instances from the plurality of devices are displayed simultaneously on the plurality of divisions of the display screen.

In a further example in accordance with the present disclosure, a non-transitory computer readable medium is provided. The non-transitory computer-readable medium comprises instructions which, when executed, cause a device to (i) establish, by a base of the display unit, connection between the display unit and a plurality of devices, wherein the plurality of instances run on the plurality of devices, and wherein the display screen comprises a plurality of divisions; and (ii) display simultaneously on the plurality of divisions of the display screen the plurality of instances.

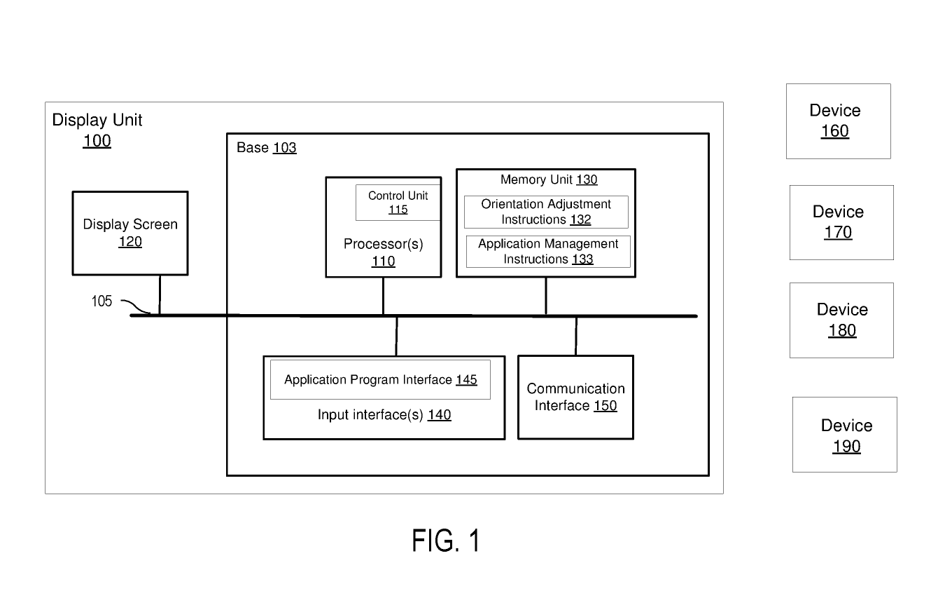

FIG. 1 is a schematic representation of an example display unit 100 connected to a plurality of devices 160-190. It should be readily apparent that the present illustration should not be interpreted to be limited by this particular illustrative architecture shown in FIG. 1, and the display unit 100 represents a generalized illustration and that other elements may be added or the illustrated elements may be removed, modified, or rearranged in many ways:

The display unit 100 includes a base 103 and a display screen 120. The base 103 includes a processor 110 (e.g., a central processing unit, a microprocessor, a microcontroller, or another suitable programmable device), a display screen 120, a memory unit 130, input interfaces 140, and a communication interface 150. Each of these components or any additional components of the display unit 100 is operatively coupled to a bus 105. The bus 105 may be any of several types of bus structures including a memory bus or memory controller, a peripheral bus, and a local bus using any of a variety of bus architectures. In other examples, the display unit 100 includes additional, fewer, or different components for carrying out similar functionality described herein.

The processor 110 includes a control unit 112 and may be implemented using any suitable type of processing system where at least one processor executes computer-readable instructions stored in the memory 130. The processor 110 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium the memory 130), or a combination thereof.

The machine readable medium 130 may be a non-transitory computer readable medium that stores machine readable instructions, codes, data, and/or other information. The instructions, when executed by processor 110 (e.g., via one processing element or multiple processing elements of the processor) can cause processor 110 to perform processes described herein.

Further, the computer readable medium 130 may participate in providing instructions to the processor 110 for execution. The machine readable medium 130 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. As discussed in more detail above, the processor 110 may be in data communication with the machine readable medium 130, which may include a combination of temporary and/or permanent storage. The machine readable medium 130 may include program memory that includes all programs and software such as an operating system, user detection software component, and any other application software programs. The machine readable medium 130 may also include data memory that may include multicast group information, various tale settings, and any other data required by any element of the ASIC.

The processor 110 includes a control unit 115 and may be implemented using any suitable type of processing system where at least one processor executes computer-readable instructions stored in the memory 130.

The communication interface 150 enables the display unit 100 to communicate with a plurality of networks and communication links. In some examples, the communication interface of the display unit 100 may include a Wi-Fi® interface, a Bluetooth interface, a 3G interface, a 4G interface, a near filed communication (NFC) interface, and/or any other suitable interface that allows the computing device to communicate via one or more networks. The networks may include any suitable type or configuration of network to allow the display unit 100 to communicate with any external systems or devices (e.g., the devices 160-190).

The input interfaces 140 can process information from the various external system, devices (e.g., the devices 160-190), and networks that are in communication with the display unit 100. For example, the input interfaces 140 include an application program interface 145. In other examples, the input interfaces 140 can include additional interfaces. More specifically, the application program interface 145 receives content or data (e.g., video, images, data packets, graphics, etc.) from the devices 160-190.

The display screen 120 may be a transparent an organic light emitting diode (OLED) display, or any other suitable display. The display screen 120 may be a flexible display that can be wrapped and unwrapped from around a bar. An attachment section of the display screen 120 facilitates a coupling of flexible display to the bar in any conventional manner. In one implementation, the flexible display may have a magnetic disclosure, and the display wrapped around the bar may be held in place with the magnetic disclosure. Alternatively, a band may be used to hold the wrapped display around the bar. In various implementations, the flexible display screen 120 may have a variety of structural configuration and material composition.

The display screen 120 is to display content from one or more applications communicated to the display unit 100. The display screen 120 may have a plurality of sections. In one implementation, the display screen 120 may be divided into three sections, and each section may display different content. In one implementation, the display screen 120 comprises various display properties such as resolution, display pixel density, display orientation and/or display aspect ratio. The display screen 120 may be of different sizes and may support various types of display resolution, where display resolution is the number of distinct pixels in each dimension that can be displayed on the display screen 120. For example, the display screen 120 may support high display resolutions of 1920×1080, or any other suitable display resolutions. When the display screen supports a 1920×1080 display resolution, 1920 is the total number of pixels across the height of the display 120 and 1080 is the total number of pixels across the height of the display 120.

As discussed above, the display unit 100 may be connected to the devices 160-190 via VGA, HDMI, USB Wi-Fi, Bluetooth, over the local network or over the internet Cloud. The devices 160-190 may be computing device, which includes one of various computing devices that have a keyboard/battery portion and a display screen portion. The computing devices may include, but not limited, to any one of various desktops, laptops, tablets, smart phones, watches and other similar devices. These devices may operate as a stationary computing device (e.g., personal computers (i,e., desktops), server computers, laptop computers (with permanently attached display screens), all in one devices, and other similar devices that possess comparable characteristics). In other implementations, these devices can be handheld devices, such as tablets and smart phones.

In One implementation, each division of the display 120 may allow for sharing of electronic content from a different devices. For example, electronic content may be in the form of a video posted to a social media service and subsequently viewed and commented on by one or more users of that social media service. Further, the display may be used as a collaboration platform between a plurality of users. Each division of the display screen may be viewed by a different user. In another implementation, all the divisions may be combined to display one instance from one device.

In order to achieve this connection between the device and the display unit 100, the display unit 100 may be paired with the device 160. In one implementation, the device 160 may be paired with the display unit 100. Such pairing is performed one time, which installs an application and authorizes the device 160. From that point forward, the installed application provides the connection in addition to synchronization of data between the device 160 and the display unit 100.

In order to achieve the pairing of the device 160 with the display unit 100, the device 160 and the display unit 100 may be connected via any connectivity mechanism (e.g., Wi-Fi, network, Bluetooth) or using near-field-communication (NFC). For example, a receiver may be implemented on the display unit 100, and when the device 160 is moved Within the NFC range, the display unit 100 may automatically detect the device 160 and pair with the device 160 initiating the display of the instance from the device 160 on the display screen 120. In another implementation, the display unit 100 may have a Bluetooth low energy beacon, which can be used to automatically recognize the devices (e.g., the device 160) within the Bluetooth zone. At that point, the display unit 100 may send a message to the device 160 to pair with it automatically. The device 160 may start to stream the instances of the device 160 on the display unit 100 after the device 160 is paired with the display unit 100. In a further implementation, the display unit 100 may be connected to the device 160 via a USB or HDMI connection.

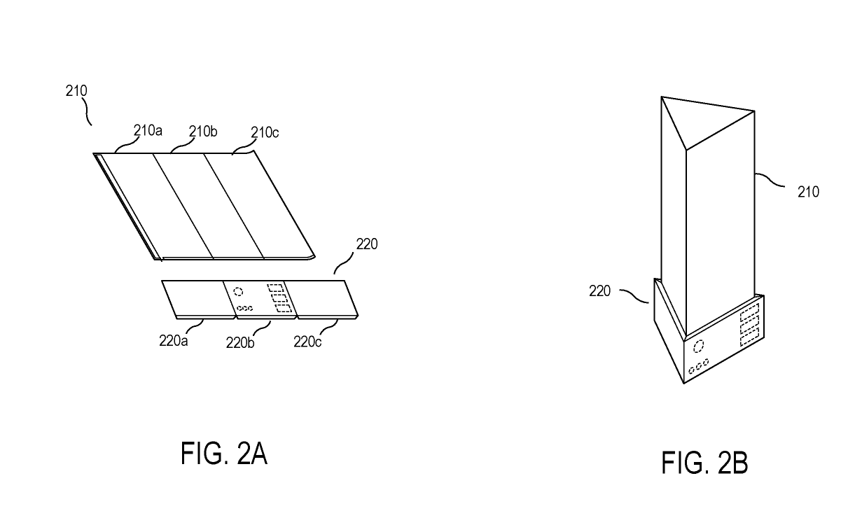

FIGS. 2A and 2B illustrate a display unit 200, according to an example. As illustrated in FIG. 2A, a plurality of instances may be displayed on screen divisions 210a, 210b and 210c of the display screen 210, and these instances may be communicated from a plurality of devices (e.g., the devices 160-190) at the same time. Base divisions 220a, 220b and 220c connect the plurality of the devices to the screen divisions 210a, 210b and 210c. For example, the device 170 may stream one instance at the division 210a and may be connected to the display by the base division 220a. At the same time, the device 180 may stream one instance at the screen division 210b and may be connected to the display via the base division 220b. It should be readily apparent that the present illustration should not be interpreted to be limited by this particular illustrative architecture shown in FIGS. 2A and 2B, and the display unit 200 represents a generalized illustration and that other elements may be added or the illustrated elements may be removed, modified, or rearranged in many ways. For example, three instances for three screen divisions and three base divisions are shown as examples, and more or less number of instances may be shown in another implementation. For example, the screen divisions 210a and 210b may display one instance, which may be streamed via the base division 220b.

In one implementation, the streamed instances on 210a, 210b and 210c from a plurality of devices may be able to interact with each other through commands executed on the display unit 200. This is enabled by software installed in the operating system of each instance,

FIG. 2B illustrates the display screen 210 connected to the base 220. In this implementation, the screen is bended to a triangular form. Such form may allow the unit to be used by a plurality of users at the same time. In other implementations, the screen and base may be kept in a linear form or can be used in a curved angle. The curved angle may be provide privacy to the user viewing the screen.

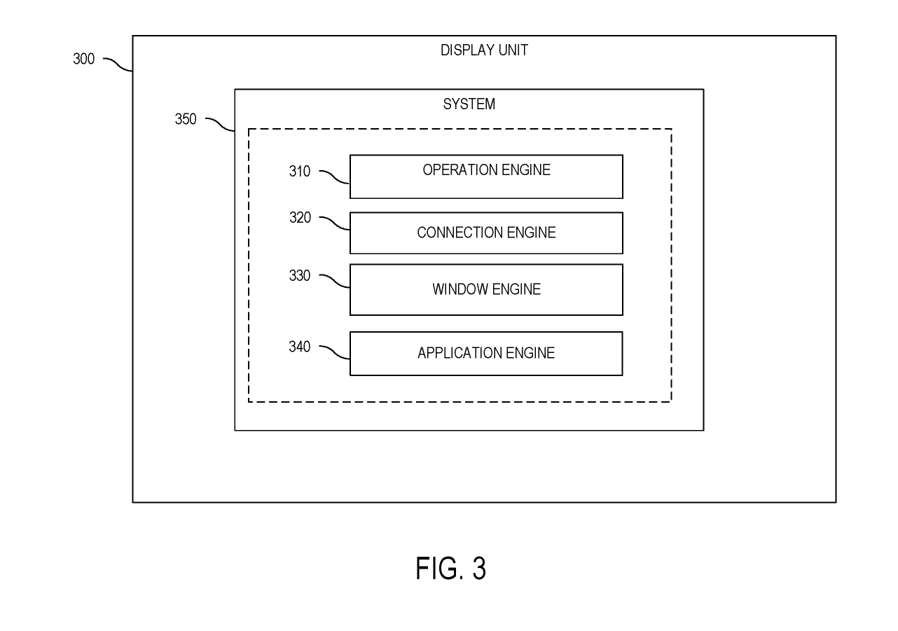

FIG. 3 illustrates an example of a display unit 300 to manage multiple instances from multiple devices via the system 350. The system 350 illustrated in FIG. 3 includes various engines to implement the functionalities described herein. The system 300 may include at least an operation engine 310, a network engine 320, window engine 330, and an application engine 340. Although the various engines 310-345 are shown as separate engines in FIG. 3, in other implementations, the functionality of all or a subset of the engines 310-345 may be implemented as a single engine.

Each of the engines of system 300 may be any suitable combination of hardware and programming to implement the functionalities of the respective engine. Such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement system 200. The machine-readable storage medium storing the instructions may be integrated in a computing device including the processing resource to execute the instructions, or the machine-readable storage medium may be separate but accessible to the computing device and the processing resource. The processing resource may comprise one processor or multiple processors included in a single computing device or distributed across multiple computing devices. In other examples,_{:} the functionalities of any of the engines may be implemented in the form of electronic circuitry.

The operation engine 310 handles an operating system, such as iOS®, Windows®, Android, and any other suitable operating system. The operating system can be multi-user, multiprocessing, multitasking, multithreading, and real-time. In one implementation, the operating system is stored in a memory (e.g., the memory 130 as shown in FIG. 1) performs various tasks related to the use and operation of the display unit 300. Such task may include installation and coordination of the various hardware components of the display unit 300, operations relating to instances from various devices in the display, recognizing input from users, such as touch on the display screen, keeping track of files and directories on memory (e.g., the memory 130 as shown in FIG. 1); and managing traffic on bus (e.g., as shown in FIG. 1).

The connection engine 320 includes various components for establishing and maintaining device connections, such as computer-readable instructions for implementing communication protocols including TCP/IP, HTTP, Ethernet®, USB®, and FireWire®. The connection engine 320 supports the pairing process between the display unit 300 and various devices providing instances to be displayed on the display unit 303.

Further, the system may include various components, such as a window engine 330. In one example, the window engine 330 may be a subset of the operation engine 310 that assists with the management of divisions on the display (e.g., the display screen 120 as shown in FIG. 1) when a new instance is communicated to the display unit 300 from a device. For example, the display may have three divisions. The window engine 330 may be used to configure the two divisions to display one instance from one device, and the third division to display another instance from another device.

The application engine 340 may manage the operation of the instances that are displayed on the display unit 300. For example, the operation engine 340 receives a command from the user to perform an action on one of the instances being displayed on the display unit 300. The user communicates the command by touching the instance window on the display screen of the display unit 300. For example, the display unit 300 may display a remote instance from a mobile device. The user may touch an image of an application shown on the display screen to launch that application on that mobile device. The operation engine 340 communicates the command received from the user to the device, and the device may launch the requested application. An updated instance may be provided to the display unit 300, and the display unit 300 may display on the display screen an instance of the application, available for the user to operate.

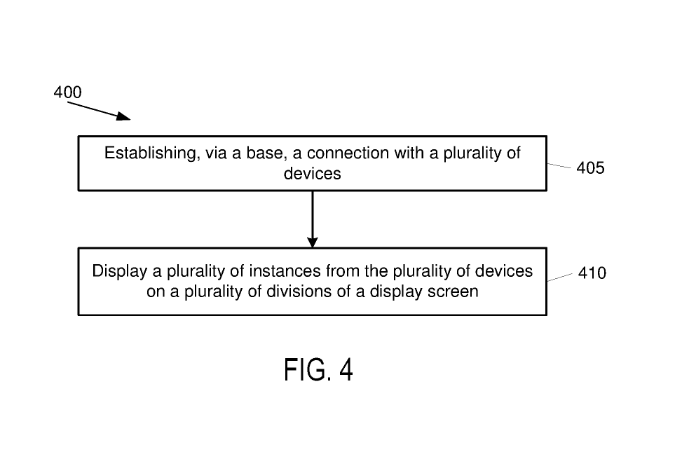

Turning now to the operation of the system 100, FIG. 4 depicts a process flow diagram 400 in accordance with an example implementation. It should be readily apparent that the processes depicted in FIG. 4 represent generalized illustrations, and that other processes may be added or the illustrated processes may be removed, modified, or rearranged in many ways. Further, it should be understood that the processes may represent executable instructions stored on memory that may cause a processing device to respond, to perform actions, to change states, and/or to make decisions, for instance. Thus, the described processes may be implemented as executable instructions and/or operations provided by a memory associated with the computing device 400.

The illustrated process 400 begins at block 405, where a connection is established between the display unit and multiple devices through the base. Multiple instances run on these devices. At block 410, the instances are displayed simultaneously on different divisions of the display screen of the display unit.

While the above disclosure has been shown and described with reference to the foregoing examples, it should be understood that other forms, details, and implementations may be made without departing from the spirit and scope of the disclosure that is defined in the following claims.

What is claimed is:

1. A display system, comprising:
a flexible display screen having a plurality of divisions; and
a base, attached to the display screen, establishing connection between a plurality of devices and the display screen, wherein instances from the plurality of devices are displayed simultaneously on the plurality of divisions of the display screen.

2. The display system of claim 1, wherein the display screen is foldable and scrollable.

3. The display system of claim 1, wherein the base comprises processing engines, comprising:
an operation engine to manage the display unit;
a connection engine to establish the connection between the display unit and the plurality of devices running the plurality of instances; and
an application engine to manage interactions between the plurality of instances displayed on the display screen.

4. The display system of claim 1, wherein the flexible display screen and the base are connected via pins, and each division of the display screen corresponds to a division of the base.

5. The display system of claim 1, wherein each division of the display screen receive a separate video input from the base.

6. The display system of claim 1, wherein the base and the plurality of devices are connected via USB, VGA, HDMI, Bluetooth or Wi-Fi.

7. The display system of claim 1, wherein the display screen is plugged into the base to enable screen power.

8. The display system of claim 1, wherein the display screen has a curved shape to provide privacy to a user of the display screen and protect the security of the content displayed on each division of the display screen.

9. A processor-implemented method for managing a plurality of instances on a display screen of a display unit, comprising:
establishing, by a base of the display unit, connection between the display unit and a plurality of devices, wherein the plurality of instances run on the plurality of devices, and wherein the display screen comprises a plurality of divisions; and
displaying simultaneously on the plurality of divisions of the display screen the plurality of instances.

10. The method of claim 9, further comprising allowing remote operation of the plurality of instances displayed on the display screen.

11. The method of claim 9, wherein allowing the remote operation of the plurality of instances displayed on the display screen comprises:
receiving, from a user, a command associated with one of the plurality of the instances running on a device; and
delivering the command to the device, wherein the device performs the command.

12. The method of claim 11, wherein receiving the command comprises receiving a touch gesture from the user on the display screen, the touch gesture targeting specific areas of the display screen, where the one of the plurality of instances is displayed.

13. A non-transitory computer-readable medium comprising instructions which, when executed, cause a display unit to:
establish, by a base of the display unit, connection between the display unit and a plurality of devices, wherein the plurality of instances run on the plurality of devices, and wherein the display screen comprise& a plurality of divisions; and
display simultaneously on the plurality of divisions of the display screen the plurality of instances.

14. The non-transitory computer-readable medium of claim 13, further comprising instructions which cause the device to provide a collaboration environment accepting inputs from the plurality of devices.
